(19) United States
(12) Patent Application Publication
(10) Pub. No.: US 2026/0247264 A1
(43) Pub. Date: Aug. 20, 2026

(54) CELL SELECTION, CELL RESELECTION, AND PUBLIC LAND MOBILE NETWORK (PLMN) SELECTION FOR SHARED NETWORK DEPLOYMENT

(71) Applicant: QUALCOMM Incorporated, San Diego, CA (US)

(72) Inventors: Peng HU, Beijing (CN); Hewu GU, Shanghai (CN); Jun DENG, Shanghai (CN); Ling XIE, Beijing (CN); Liang HONG, Beijing (CN); Xuqiang ZHANG, Beijing (CN); Xiaochen CHEN, Beijing (CN); Yong HOU, Beijing (CN); Xiaoning LU, San Diego, CA (US); Shan QING, San Diego, CA (US); Zhongyue LOU, Beijing (CN); Tom CHIN, San Diego, CA (US)

(21) Appl. No.: 19/642,526

(22) Filed: Apr. 8, 2026

Related U.S. Application Data
(62) Division of application No. 18/016,848, filed on Sep. 3, 2021.

(30) Foreign Application Priority Data
Sep. 10, 2020 (WO) PCT/CN2020/114458

(51) Int. Cl. H04W 48/08; H04W 48/02; H04W 48/20

(52) U.S. Cl. CPC H04W 48/08; H04W 48/02; H04W 48/20

(57) ABSTRACT

A user equipment (UE) receives a SIB1 message from a base station. The SIB1 message lists first and second public land mobile network identifiers (PLMN IDs), the first PLMN ID having a corresponding tracking area code (TAC) and the second PLMN ID not having a TAC. The UE reports the first PLMN ID and TAC but not the second PLMN ID while performing PLMN selection. In another aspect, the UE unsuccessfully attempts to select or reselect to a shared cell of the base station with the second PLMN ID. In response to the failed attempt, the UE bars the shared cell as a candidate for cell selection/reselection, due to a missing TAC. When the UE attempts to select or reselect to the shared cell with the first PLMN ID, which may or may not have a TAC, the UE reevaluates the barring due to selection of the first PLMN ID.

### CROSS REFERENCE TO RELATED APPLICATIONS

The present application is a divisional of U.S. patent application Ser. No. 18/016,848, filed on Jan. 18, 2023, and entitled “CELL SELECTION, CELL RESELECTION, AND PUBLIC LAND MOBILE NETWORK (PLMN) SELECTION FOR SHARED NETWORK DEPLOYMENT,” which is a 371 National Stage of PCT Patent Application No. PCT/CN2021/116401, filed on Sep. 3, 2021, and entitled “CELL SELECTION, CELL RESELECTION, AND PUBLIC LAND MOBILE NETWORK (PLMN) SELECTION FOR SHARED NETWORK DEPLOYMENT,” which claims priority under 35 U.S.C. § 119 to PCT Patent Application No. PCT/CN2020/114458, filed on Sep. 10, 2020, and entitled “CELL SELECTION, CELL RESELECTION, AND PUBLIC LAND MOBILE NETWORK (PLMN) SELECTION FOR SHARED NETWORK DEPLOYMENT,” the disclosures of which are expressly incorporated by reference in their entireties.

### FIELD OF THE DISCLOSURE

Aspects of the present disclosure generally relate to wireless communications, and more particularly to techniques and apparatuses for improved cell selection, cell reselection, and public land mobile network (PLMN) selection processes for shared network deployments.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method of wireless communication by a user equipment (UE) includes decoding a system information block, type one (SIB1) message received from a base station. The SIB1 message lists: a first public land mobile network identifier (PLMN ID) having a corresponding tracking area code (TAC), and a second PLMN ID with no corresponding TAC. The method further includes reporting the first PLMN ID and the corresponding TAC but not reporting the second PLMN ID while performing PLMN selection.

In other aspects of the present disclosure, a method of wireless communication by a user equipment (UE) includes decoding a system information block, type one (SIB1) message received from a base station shared among multiple network operators. The SIB1 message lists: a first public land mobile network identifier (PLMN ID) associated with a first of the network operators, and a second PLMN ID associated with a second of the network operators and having no corresponding TAC. The method also includes attempting to select or reselect to a shared cell of the base station with the second PLMN ID. The method further includes barring the shared cell as a candidate for cell selection or cell reselection, in response to failing to camp on the shared cell due to a missing TAC. The method still further includes attempting to select or reselect to the shared cell with the first PLMN ID. The method still further includes reevaluating the barring due to selection of the first PLMN ID.

Other aspects of the present disclosure are directed to an apparatus for wireless communications by a user equipment (UE) having a processor and memory coupled with the processor. The processor is configured to decode a system information block, type one (SIB1) message received from a base station. The SIB1 message lists a first public land mobile network identifier (PLMN ID) having a corresponding tracking area code (TAC), and a second PLMN ID with no corresponding TAC. The processor is further configured to report the first PLMN ID and the corresponding TAC but not reporting the second PLMN ID while performing PLMN selection.

Other aspects of the present disclosure are directed to an apparatus for wireless communications by a user equipment (UE) having a processor and memory coupled with the processor. The processor is configured to decode a system information block, type one (SIB1) message received from a base station shared among multiple network operators. The SIB1 message lists a first public land mobile network identifier (PLMN ID) associated with a first of the group of network operators, and a second PLMN ID associated with a second of the network operators and having no corresponding tracking area code (TAC). The processor is further configured to attempt to select or reselect to a shared cell of the base station with the second PLMN ID. The processor is also configured to bar the shared cell as a candidate for cell selection or cell reselection, in response to failing to camp on the shared cell due to a missing TAC. The processor is still further configured to attempt to select or reselect to the shared cell with the first PLMN ID. The processor is still further configured to reevaluate the barring due to selection of the first PLMN ID.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a diagram illustrating contents of a system information block, type one (SIB) message, in accordance with aspects of the present disclosure.

FIG. 4 is a call flow diagram illustrating public land mobile network (PLMN) selection, in accordance with aspects of the present disclosure.

FIG. 5 is a call flow diagram illustrating cell selection or cell reselection, in accordance with aspects of the present disclosure.

FIG. 6 is a flow diagram illustrating an example process performed, for example, by a user equipment (UE), in accordance with various aspects of the present disclosure.

FIG. 7 is a flow diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Some network operators may reduce costs by sharing network infrastructure with other network operators. For example, an access network may be shared among two or more network operators. Each network operator, however, maintains its own core network even though access network components, such as base stations, may be shared. Certain end users may subscribe to both network operators.

If multiple network operators share a cell, a user equipment (UE) of an end user receives a system information block, type one (SIB1) message including a public land mobile network (PLMN) identifier (ID) for both network operators. While a tracking area code (TAC) is mandatory for technology prior to 5G (e.g., 4G or 3G), in 5G the TAC is optional in SIB1. Thus, the PLMN ID for one operator may not be associated with the TAC.

A UE subscribing to both network operators, when receiving the SIB1 message from the shared cell, may trigger PLMN selection. According to existing procedures, after decoding the received SIB1 of the shared cell, the access stratum (AS) layer reports all PLMN IDs in the decoded SIB1 to the non-access stratum (NAS) layer regardless of whether the TAC is present. If this is the case when PLMN selection occurs, the UE may fail to camp on a cell, due to the missing TAC.

Stated another way, for manual PLMN selection or high priority PLMN selection, if the user equipment (UE) finds a shared cell, the UE reports the PLMNs with and without TACs. When the UE later selects a cell corresponding to a reported PLMN without a TAC, the UE will not be able to camp on the cell. According to aspects of the present disclosure, when reporting available PLMNs after reading the SIB1 message from a shared cell, the UE does not report any PLMN for which there is no corresponding TAC. That is, the UE only reports available PLMN IDs having corresponding TACs in the SIB1 message.

Another issue with existing procedures arises during cell selection or cell reselection. When multiple PLMNs are present in the decoded SIB1 message, the UE may attempt to camp on a cell using a PLMN without a TAC. In this case, according to 3GPP TS 38.304, the cell is to be treated as if the cell status is ‘barred’ because of no corresponding TAC in SIB1. The UE then excludes the barred cell as a candidate for cell selection and cell reselection for a period of time, such as up to 300 seconds. At a later time (e.g., less than 300 seconds afterwards), for cell selection and/or reselection, the UE may request the same shared cell with a different PLMN that is associated with a TAC. According to current procedures, the UE will not consider this cell because this cell was already barred, even though this cell could be treated as a suitable cell.

According to aspects of the present disclosure, the UE should unbar or reevaluate unbarring of the shared cell when the requested PLMN is different. The unbarring may occur prior to PLMN selection when the PLMN changes. Whether to unbar the shared cell may be decided blindly or based on a history record. In other aspects, unbarring occurs when the UE determines the new PLMN is associated with a TAC.

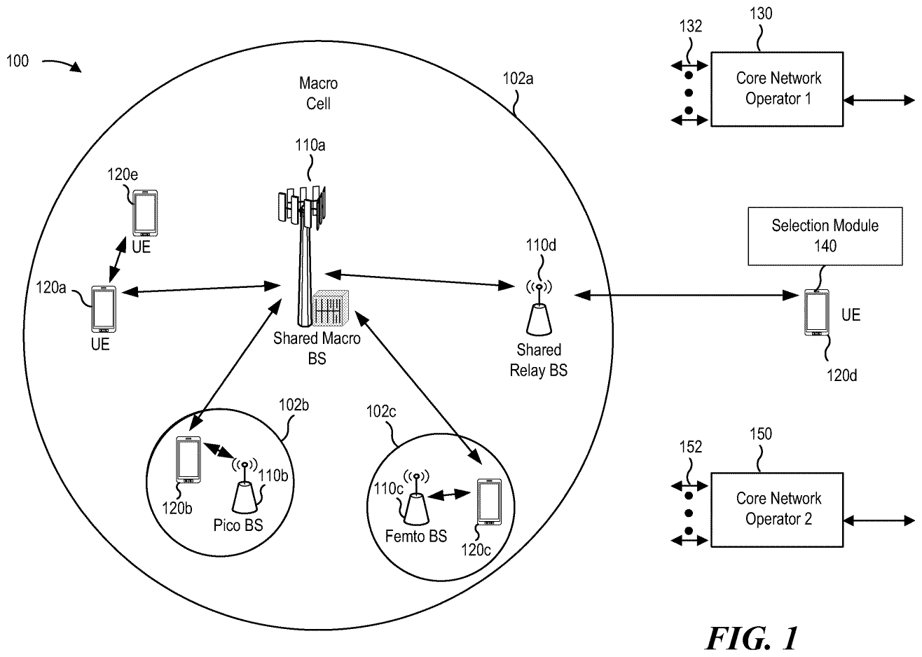

FIG. 1 is a diagram illustrating a shared network 100 in which aspects of the present disclosure may be practiced. The shared network 100 may be a 5G or NR network or some other wireless network, such as an LTE network. The shared wireless network 100 may include a number of shared BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G node B (NB), an access point, a transmit and receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “TRP,” “AP,” “node B,” “5G NB,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

As an example, the BSs 110 (shown as BS 110a, BS 110b, BS 110c, and BS 110d) and the core network 130, 150 may exchange communications via backhaul links 132, 152 (e.g., S1, etc.). Base stations 110 may communicate with one another over other backhaul links (e.g., X2, etc.) either directly or indirectly (e.g., through one of the core networks 130, 150).

Multiple core networks may share the base station 110. For example, a core network 130 of a first network operator may be an evolved packet core (EPC), which may include at least one mobility management entity (MME), at least one serving gateway (S-GW), and at least one packet data network (PDN) gateway (P-GW). A core network 150 of a second network operator may be similarly configured. The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to each of the network operator's IP services. The operators'IP services may include the Internet, the Intranet, an IP multimedia subsystem (IMS), and a packet-switched (PS) streaming service.

The core networks 130, 150 may provide user authentication, access authorization, tracking, IP connectivity, and other access, routing, or mobility functions. One or more of the base stations 110 or access node controllers (ANCs) may interface with the core networks 130, 150 through backhaul links 132, 152 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless communications system 100, while also satisfying performance specifications of individual applications of the UE 120. In some cases, the network slices used by UE 120 may be served by an AMF (not shown in FIG. 1) associated with one or both of the base station 110 or core network 130, 150. In addition, session management of the network slices may be performed by an access and mobility management function (AMF).

The UEs 120 may include a selection module 140. For brevity, only one UE 120d is shown as including the selection module 140. The selection module 140 may decode a system information block, type one (SIB1) message received from a base station including two PLMN IDs, and may report a PLMN ID with a TAC but not report a PLMN ID without a TAC, while performing PLMN selection. The selection module 140 may also decode a SIB1 message received from a base station shared among a number of network operators, including two PLMN IDs, and may attempt to select or reselect to a shared cell of the base station with the second PLMN ID. The selection module 140 may also bar the shared cell as a candidate for cell selection or cell reselection, in response to failing to camp on the shared cell due to a missing TAC and then attempt to select or reselect to the shared cell with the first PLMN ID. The selection module 140 may further reevaluate the barring due to selection of the first PLMN ID.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband IoT) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

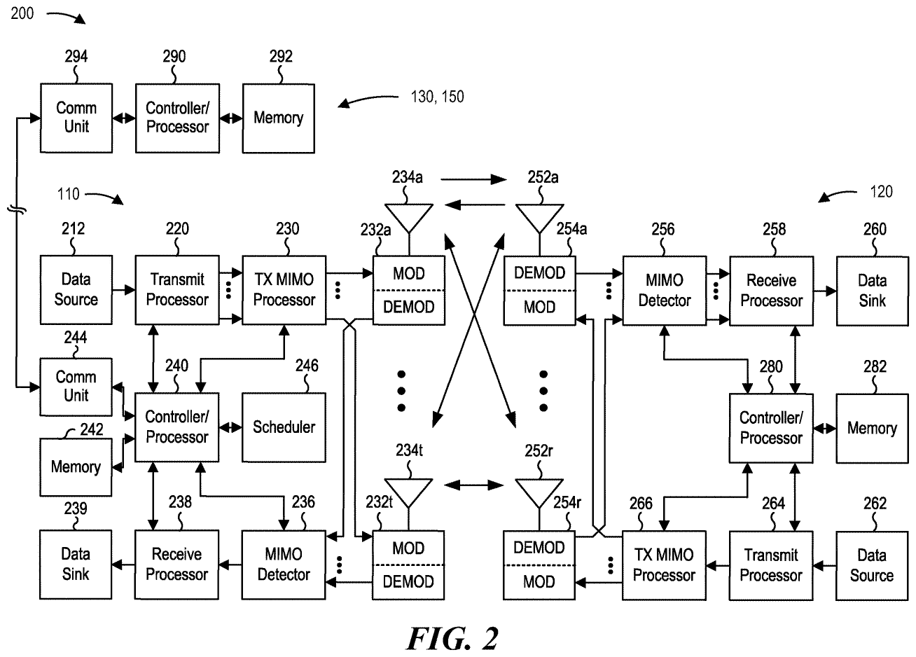

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130, 150 via the communications unit 244. Each core network 130, 150 may include a communications unit 294, a controller/processor 290, and a memory 292.

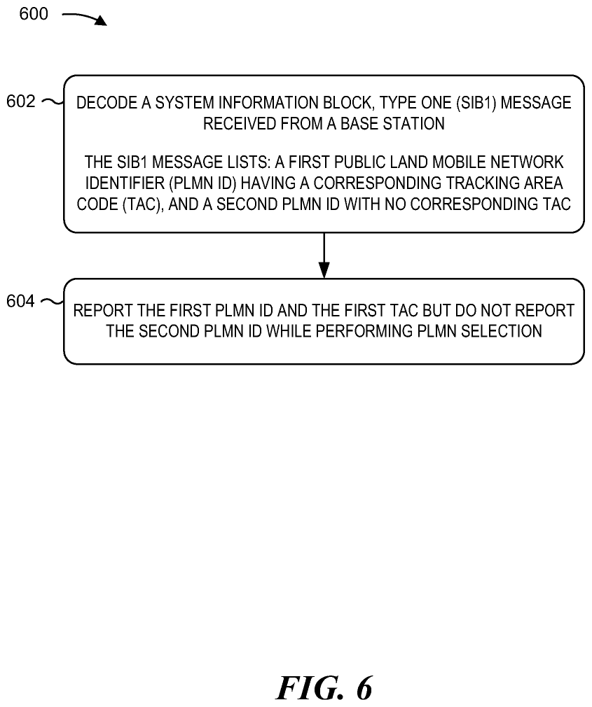

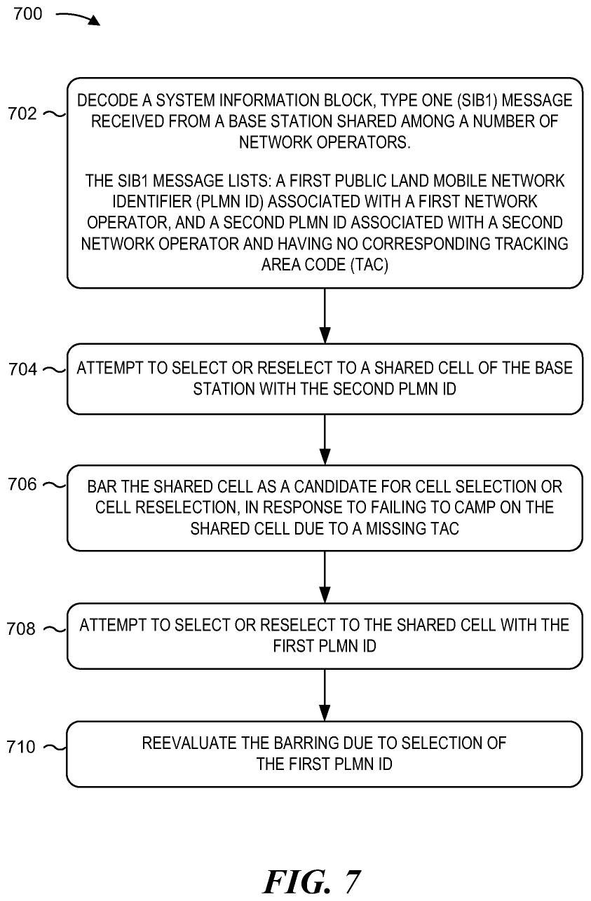

The controller/processor 280 of the UE 120, and/or any other component(s) of FIG. 2 may perform one or more techniques associated with selection in a shared network as described in more detail elsewhere. For example, the controller/processor 280 of the UE 120, and/or any other component(s) of FIG. 2 may perform or direct operations of, for example, the process of FIGS. 6 and 7 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for decoding, means for reporting, means for attempting, means for barring, means for reevaluating, means for unconditionally unbarring, means for determining, means for unbarring, and/or means for camping. Such means may include one or more components of the UE 120 described in connection with FIG. 2.

As indicated above, FIG. 2 is provided merely as an example. Other examples may differ from what is described with regard to FIG. 2.

As described previously, some network operators may reduce costs by sharing network infrastructure with other network operators. For example, an access network may be shared among two or more network operators. Each network operator, however, maintains its own core network even though access network components, such as base stations, may be shared. Certain end users may subscribe to both network operators. Thus, a UE may receive a system information block, type one (SIB1) message including information from each of the network operators.

Some 5G network deployments may be referred to as standalone (SA) deployments, whereas other network deployments may be referred to as non-standalone (NSA) deployments. A standalone 5G deployment relies entirely on 5G components. A non-standalone deployment relies on a combination of older wireless network infrastructure, such as a 4G or even 3G components, and 5G infrastructure. For example, the core network may be 4G, whereas the base station is 5G in a non-standalone deployment.

In some shared networks, NSA network operators and SA network operators may share the same cells. In this scenario, a system information block, type one (SIB1) message includes a public land mobile network (PLMN) identifier (ID) for the SA network operator and also a PLMN ID for the NSA network operator. While a tracking area code (TAC) is mandatory for technology prior to 5G (e.g., 4G or 3G), in 5G the TAC is optional in SIB1. Thus, the PLMN ID for the NSA operator may not be associated with the TAC. For the SA network operator, the TAC is included in the SIB1 message, along with the PLMN ID.

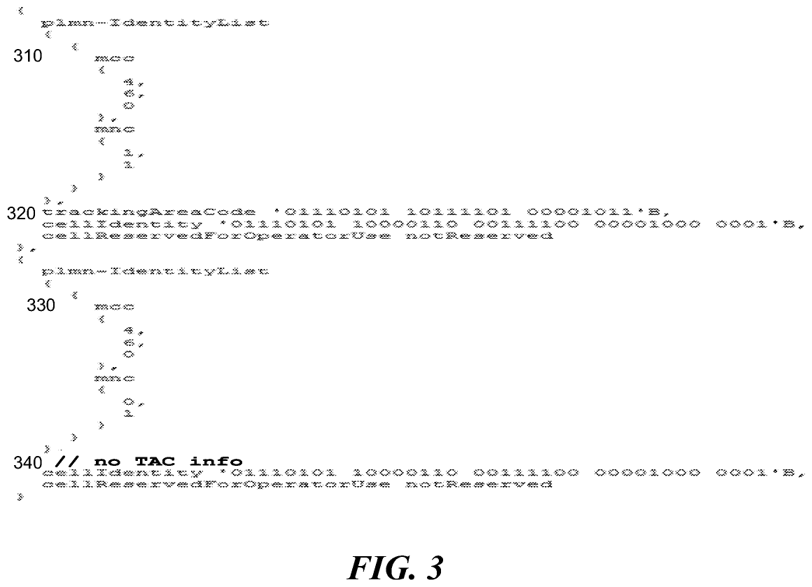

FIG. 3 is a diagram illustrating contents of a system information block, type one (SIB1) message, in accordance with aspects of the present disclosure. In FIG. 3, a first PLMN ID 310 is associated with a TAC 320. A second PLMN ID 330, however, is not associated with a TAC 340. In this example, the network operator associated with the first PLMN ID 310 operates in a SA mode, and the network operator associated with the second PLMN ID 330 operates in an NSA mode.

A UE may trigger PLMN selection and receive a SIB1 message from the shared cell. For example, upon power up or when returning from an area with no coverage, PLMN selection may automatically occur. In other examples, PLMN selection occurs when manually attempting to select a network or when a higher priority PLMN selection is desired. For example, if a UE does not camp on a home PLMN, the UE may attempt to find the home PLMN, which has a higher priority than the current PLMN.

According to existing procedures, after decoding the received SIB1 of the shared cell, the access stratum (AS) layer of the UE reports all PLMN IDs in the decoded SIB1, to the non-access stratum (NAS) layer of the UE regardless of whether the TAC is present. If this is the case, and if the PLMN selection is triggered by the end user, the end user may later select the PLMN not having a corresponding TAC. Due to the missing TAC, the UE will fail to camp on the cell, resulting in a poor user experience.

If a PLMN without a TAC is registered, and if the PLMN selection is triggered because of another reason, such as high priority PLMN selection, the UE may later attempt to camp on the PLMN without a TAC. Due to the missing TAC, the UE will fail to camp on the cell, and the UE will be out of service for a period of time.

Stated another way, for manual PLMN selection or high priority PLMN selection, if the user equipment (UE) finds a shared cell, the UE reports the PLMNs with and without TACs. When the UE later selects a cell corresponding to a reported PLMN without a TAC, the UE will fail to camp on the cell. According to aspects of the present disclosure, when reporting available PLMNs after reading the SIB1 message from a shared cell, the UE does not report any PLMN for which there is no corresponding TAC. That is, the UE only reports available PLMN IDs having a corresponding TAC in the SIB1 message.

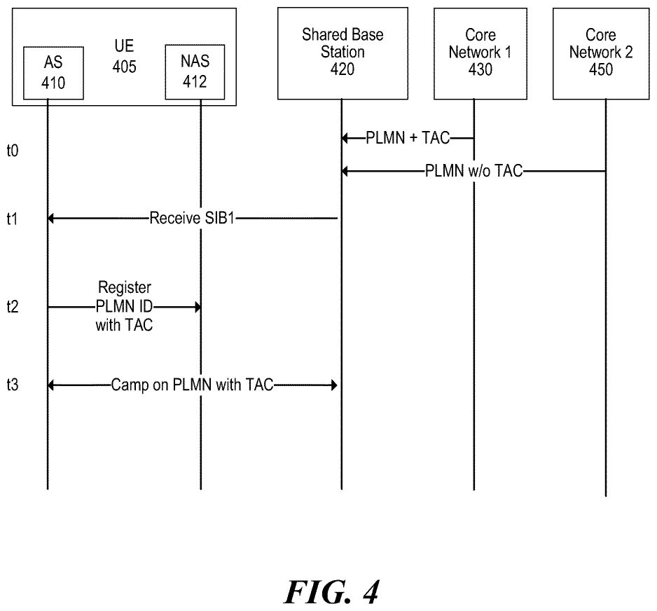

FIG. 4 is a call flow diagram illustrating public land mobile network (PLMN) selection, in accordance with aspects of the present disclosure. At time t0, a first core network 430, associated with a first network operator in a SA mode sends its PLMN ID and its TAC to a shared base station 420. A second core network 450, associated with a second network operator in an NSA mode, also sends its PLMN ID to the shared base station 420 at time t0. The second core network 450 does not send a TAC.

At time t1, an access stratum (AS) layer 410 of a UE 405 receives, from the shared base station 420, a SIB1 message including the PLMN IDs of the first and second core networks 430, 450. According to aspects of the present disclosure, the AS layer 410 registers, with the UE non-access stratum (NAS) layer 412, only the PLMN ID having a TAC, at time t2. In this example, the UE AS layer 410 registers the PLMN ID associated with the first core network 430, but not the PLMN ID associated with the second core network 450. At time t3, the UE 405 camps on the cell of the shared base station 420, using the PLMN ID associated with the TAC, in other words, the network of the first network operator.

As described above, another issue with existing procedures arises during cell selection or cell reselection. When multiple PLMNs are present in the decoded SIB1 message, the UE may attempt to camp on a cell using a PLMN without a TAC. In this case, according to 3GPP specification TS 38.304, the cell is to be treated as if the cell status is ‘barred’ because of no corresponding TAC in SIB1. The UE then excludes the barred cell as a candidate for cell selection and cell reselection for up to 300 seconds. At a later time (e.g., less than 300 seconds afterwards), for cell selection and/or reselection, the UE may request the same shared cell with a different PLMN that is associated with a TAC. According to current procedures, the UE will not consider this cell because this cell was already barred, even though this cell could be treated as a suitable SA cell.

According to aspects of the present disclosure, the UE should unbar the shared cell when the requested PLMN is different. The unbarring may occur prior to PLMN selection when the PLMN changes. Whether to unbar the shared cell may be decided blindly or based on a history record. For example, the UE may decide to unbar the cell when the history shows the cell was barred previously and the SIB1 message has at least two PLMN IDs, with at least one of the PLMN IDs missing a TAC and with at least one of the PLMN IDs being associated with a TAC.

In some aspects, the UE further checks the new PLMN to determine whether it is associated with a TAC. If the new PLMN is associated with a TAC, the UE unbars the cell. For example, consider the case when both PLMNs have no TAC. In this case, the UE does not unbar the shared cell when the requested PLMN is different. Rather, the UE checks the new PLMN to determine if a TAC is present. Because no TAC is present in this case, the UE does not unbar the cell. Without this determination, the UE may unbar the cell, even though the UE would not be able to camp on the new cell. With this determination, the UE can camp on the cell quickly without wasting power.

More generally, the UE may check to see if a condition that triggered the barring of a cell still exists, prior to unbarring the cell. Examples of such conditions include missing system information, a missing TAC (as described above), authentication failure, or information missing from the network. Other examples include the network placing a cell on a blacklist due to an overload condition or an emergency, or the cell is reserved for military use. Another examples include the UE placing a cell on a blacklist due to repeated power limiting RACH failure, due to repeated power limiting RLF (Radio Link Failure), due to SAR (Specific Absorption Rate) limitations RACH failure (SAR power limiting RACH failures), due to SAR limitations RLF (SAR power limiting RLF), due to MPE (Maximum Permissible Exposure) limitations RACH failure (MPE power limiting RACH failures), due to MPE limitations RLF (MPE power limiting RLF). If the condition triggering the barring no longer exists, the UE may unbar the cell. For example, if the information missing from the network is obtained, the UE may unbar the cell. For example, if the UE has enough power to complete RACH procedure, if the UE has enough power to recover from RLF, if the SAR limitation is gone (no longer exists), if the MPE limitation is resolved (no longer exists), the UE may unbar the cell.

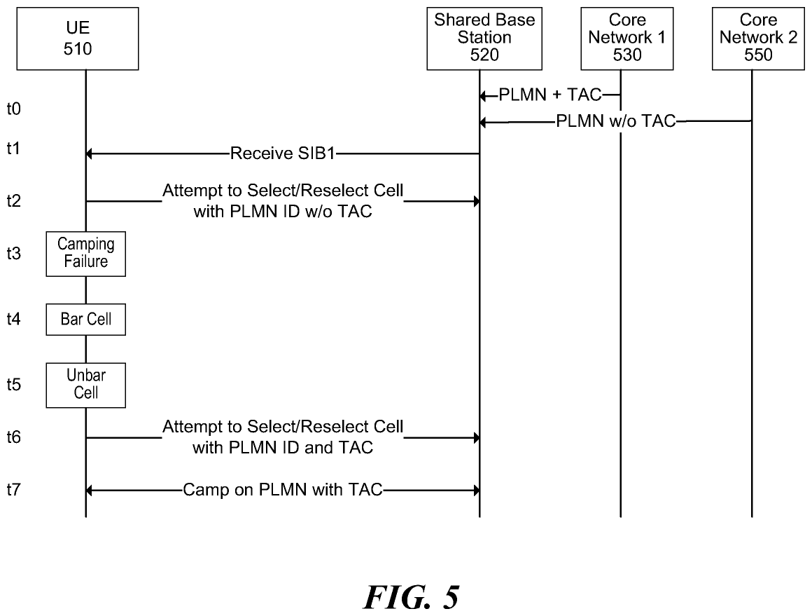

FIG. 5 is a call flow diagram illustrating cell selection or cell reselection, in accordance with aspects of the present disclosure. At time t0, a first core network 530, associated with a first network operator in a SA mode sends its PLMN ID and its TAC to a shared base station 520. A second core network 550, associated with a second network operator in an NSA mode also sends its PLMN ID to the shared base station 520 at time t0. The second core network 550 does not send a TAC with its PLMN ID. At time t1, a UE 510 receives, from the shared base station 520, a SIB1 message including the PLMN IDs of the first and second core networks 530, 550, and the TAC of the first core network 530.

At time t2, the UE 510 attempts to select or reselect to the cell of the shared base station 520 with the PLMN ID missing a TAC. Due to the missing TAC, at time t3, the UE 510 fails to camp on the base station 520 with the PLMN ID missing the TAC. In accordance with 3GPP TS 38.304, the UE 510 bars the cell of the shared base station 520, at time t4. At time t5, the UE 510 unbars the shared cell (e.g., shared base station 520). The unbarring may be based on a cell history, may occur blindly, or may occur after confirming the new PLMN ID is associated with a TAC. Thus, when attempting to select or reselect to the shared cell with the PLMN ID having the TAC, at time t6, the UE 510 is able to camp on the shared base station 520, at time t7.

As indicated above, FIGS. 3-5 are provided as examples. Other examples may differ from what is described with respect to FIGS. 3-5.

FIG. 6 is a diagram illustrating an example process 600 performed, for example, by a UE, in accordance with various aspects of the present disclosure. The example process 600 is an example of PLMN selection for a shared network deployment.

As shown in FIG. 6, in some aspects, the process 600 may include decoding a system information block, type one (SIB1) message received from a base station. The SIB1 message lists: a first public land mobile network identifier (PLMN ID) having a corresponding tracking area code (TAC), and a second PLMN ID with no corresponding TAC (block 602). For example, the user equipment (UE) (e.g., using the antenna 252, DEMOD/MOD 254, MIMO detector 256, receive processor 258, controller/processor 280, and/or memory 282) can decode the SIB1 message. The SIB1 message may correspond to a cell of the base station. The cell is shared by the network operators that have the first and second PLMN IDs. In some aspects, the first PLMN ID corresponds to a standalone deployment and the second PLMN ID corresponds to a non-standalone deployment.

The process 600 may include reporting the first PLMN ID and the first TAC but not reporting the second PLMN ID while performing PLMN selection (block 604). For example, the UE (e.g., using the antenna 252, DEMOD/MOD 254, TX MIMO processor 266, transmit processor 264, controller/processor 280, and/or memory 282) can perform the reporting. The reporting may be performed by a non-access stratum layer of the UE. As a result of reporting only the PLMN IDs associated with TACs, the UE is able to efficiently select a PLMN.

FIG. 7 is a diagram illustrating an example process 700 performed, for example, by a UE, in accordance with various aspects of the present disclosure. The example process 700 is an example of cell selection or cell reselection for shared network deployment.

As shown in FIG. 7, in some aspects, the process 700 may include decoding a system information block, type one (SIB1) message received from a base station shared among network operators. The SIB1 message lists: a first public land mobile network identifier (PLMN ID) associated with a first network operator and having a corresponding tracking area code (TAC), and a second PLMN ID associated with a second network operator and having no corresponding TAC (block 702). For example, the user equipment (UE) (e.g., using the antenna 252, DEMOD/MOD 254, TX MIMO detector 256, receive processor 258, controller/processor 280, and/or memory 282) can decode the SIB1 message. One of the network operators may operate in a stand-alone deployment while the other may operate in a non-standalone deployment.

The process 700 may include attempting to select or reselect to a shared cell of the base station with the second PLMN ID (block 704). For example, the UE (e.g., using the antenna 252, DEMOD/MOD 254, MIMO detector 256, TX MIMO processor 266, receive processor 258, transmit processor 264, controller/processor 280, and/or memory 282) can attempt to select or reselect to a shared cell. The cell may be shared by the first and second network operators. The attempting may be performed with an access stratum (AS) layer of the UE.

As shown in FIG. 7, in some aspects, the process 700 may include barring the shared cell as a candidate for cell selection or cell reselection, in response to failing to camp on the shared cell due to a missing TAC (block 706). For example, the UE (e.g., using the controller/processor 280 and/or memory 282) can bar the shared cell. The barring may be in accordance with 3GPP TS 38.304 due to the missing TAC.

The process 700 may include attempting to select or reselect to the shared cell with the first PLMN ID (block 708). For example, the UE (e.g., using the antenna 252, DEMOD/MOD 254, MIMO detector 256, TX MIMO processor 266, receive processor 258, transmit processor 264, controller/processor 280, and/or memory 282) can attempt to select or reselect to the shared cell. The first PLMN ID has a corresponding TAC.

The process 700 may include reevaluating the barring due to selection of the first PLMN ID (block 710). For example, the UE (e.g., using the controller/processor 280 and/or memory 282) can reevaluate the barring. In some aspects, the UE may blindly unbar the cell based on the reevaluating. In other aspects, the unbarring is based on a cell history. In still other aspects, the unbarring occurs only when the first PLMN ID has a corresponding TAC, as in this example. If the first PLMN ID did not have a corresponding TAC, the UE may not unbar the shared cell.

Implementation examples are described in the following numbered clauses.
1. A method of wireless communication by a user equipment (UE), comprising:
decoding a system information block, type one (SIB1) message received from a base station, the SIB1 message listing: a first public land mobile network identifier (PLMN ID) having a corresponding tracking area code (TAC), and a second PLMN ID with no corresponding TAC; and
reporting the first PLMN ID and the corresponding TAC but not reporting the second PLMN ID while performing PLMN selection.
2. The method of clause 1, in which the SIB1 message corresponds to a cell of the base station, and the cell is shared by a plurality of network operators.
3. The method of clause 1 or 2, in which the first PLMN ID corresponds to a standalone mode (SA) deployment and the second PLMN ID corresponds to a non-standalone (NSA) deployment.
4. The method of any of the preceding clauses, in which the reporting is performed by an access stratum (AS) layer of the UE to a non-access stratum (NAS) layer of the UE.
5. The method of any of the preceding clauses, further comprising camping on a cell of the base station with the first PLMN ID.
6. A method of wireless communication by a user equipment (UE), comprising:
decoding a system information block, type one (SIB1) message received from a base station shared among a plurality of network operators, the SIB1 message listing: a first public land mobile network identifier (PLMN ID) associated with a first of the plurality of network operators, and a second PLMN ID associated with a second of the plurality of network operators and having no corresponding tracking area code (TAC);
attempting to select or reselect to a shared cell of the base station with the second PLMN ID;
barring the shared cell as a candidate for cell selection or cell reselection, in response to failing to camp on the shared cell due to a missing TAC;
attempting to select or reselect to the shared cell with the first PLMN ID; and
reevaluating the barring due to selection of the first PLMN ID.
7. The method of clause 6, in which the first PLMN ID corresponds to a standalone (SA) deployment and the second PLMN ID corresponds to a non-standalone (NSA) deployment.
8. The method of clause 6 or 7, in which attempting is performed by an access stratum (AS) layer of the UE.
9. The method of any of the clauses 6-8, further comprising camping on the shared cell with the first PLMN ID.
10. The method of any of the clauses 6-9, further comprising:
determining whether a condition causing the shared cell to be barred still exists; and
unbarring the shared cell when the condition no longer exists.
11. The method of any of the clauses 6-10, further comprising:
determining whether the first PLMN ID has a corresponding TAC; and
unbarring the shared cell only when the first PLMN ID is determined to have the corresponding TAC.
12. The method of any of the clauses 6-9, further comprising unconditionally unbarring the shared cell.
13. The method of any of the clauses 6-9, further comprising unbarring the shared cell based on a cell history.
14. An apparatus for wireless communications by a user equipment (UE), comprising:
a processor;
memory coupled with the processor; and
instructions stored in the memory and operable, when executed by the processor, to cause the apparatus:
   to decode a system information block, type one (SIB1) message received from a base station, the SIB1 message listing: a first public land mobile network identifier (PLMN ID) having a corresponding tracking area code (TAC), and a second PLMN ID with no corresponding TAC; and
   to report the first PLMN ID and the corresponding TAC but not reporting the second PLMN ID while performing PLMN selection.
15. The apparatus of clause 14, in which the SIB1 message corresponds to a cell of the base station, and the cell is shared by a plurality of network operators.
16. The apparatus of clause 14 or 15, in which the first PLMN ID corresponds to a standalone mode (SA) deployment and the second PLMN ID corresponds to a non-standalone (NSA) deployment.
17. The apparatus of any of the clauses 14-16, in which the processor causes the apparatus to report from an access stratum (AS) layer of the UE to a non-access stratum (NAS) layer of the UE.
18. The apparatus of any of the clauses 14-17, in which the processor causes the apparatus to camp on a cell of the base station with the first PLMN ID.
19. An apparatus for wireless communications by a user equipment (UE), comprising:
a processor;
memory coupled with the processor; and
instructions stored in the memory and operable, when executed by the processor, to cause the apparatus:
   to decode a system information block, type one (SIB1) message received from a base station shared among a plurality of network operators, the SIB1 message listing: a first public land mobile network identifier (PLMN ID) associated with a first of the plurality of network operators, and a second PLMN ID associated with a second of the plurality of network operators and having no corresponding tracking area code (TAC);
   to attempt to select or reselect to a shared cell of the base station with the second PLMN ID;
   to bar the shared cell as a candidate for cell selection or cell reselection, in response to failing to camp on the shared cell due to a missing TAC; and
   to reevaluate the barring due to selection of the first PLMN ID.
20. The apparatus of clause 19, in which the first PLMN ID corresponds to a standalone (SA) deployment and the second PLMN ID corresponds to a non-standalone (NSA) deployment.
21. The apparatus of clause 19 or 20, in which the processor causes the apparatus to attempt cell selection or reselection by an access stratum (AS) layer of the UE.
22. The apparatus of any of the clauses 19-21, in which the processor causes the apparatus to camp on the shared cell with the first PLMN ID.
23. The apparatus of any of the clauses 19-22, in which the at least one processor is further configured:
to determine whether a condition causing the shared cell to be barred still exists; and
to unbar the shared cell when the condition no longer exists.
24. The apparatus of any of the clauses 19-23, in which the at least one processor is further configured:
to determine whether the first PLMN ID has a corresponding TAC; and
to unbar the shared cell only when the first PLMN ID is determined to have the corresponding TAC.
25. The apparatus of any of the clauses 19-22, in which the at least one processor is further configured to unconditionally unbar the shared cell.
26. The apparatus of any of the clauses 19-22, in which the at least one processor is further configured to unbar the shared cell based on a cell history.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.”

Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by a user equipment (UE), comprising:
decoding a system information block, type one (SIB1) message received from a base station, the SIB1 message listing: a first public land mobile network identifier (PLMN ID) having a corresponding tracking area code (TAC), and a second PLMN ID with no corresponding TAC; and
reporting the first PLMN ID and the corresponding TAC but not reporting the second PLMN ID while performing PLMN selection.

2. The method of claim 1, in which the SIB1 message corresponds to a cell of the base station, and the cell is shared by a plurality of network operators.

3. The method of claim 1, in which the first PLMN ID corresponds to a standalone mode (SA) deployment and the second PLMN ID corresponds to a non-standalone (NSA) deployment.

4. The method of claim 1, in which the reporting is performed by an access stratum (AS) layer of the UE to a non-access stratum (NAS) layer of the UE.

5. The method of claim 1, further comprising camping on a cell of the base station with the first PLMN ID.

6. The method of claim 1, further comprising, during a manual PLMN selection procedure, reporting the first PLMN ID and the corresponding TAC but not reporting the second PLMN ID.

7. The method of claim 1, further comprising, during a high priority PLMN selection procedure, reporting the first PLMN ID and the corresponding TAC but not reporting the second PLMN ID.

8. An apparatus for wireless communications by a user equipment (UE), comprising:
at least one processor;
memory coupled with the at least one processor; and
instructions stored in the memory and operable, when executed by the at least one processor, to cause the apparatus:
to decode a system information block, type one (SIB1) message received from a base station, the SIB1 message listing: a first public land mobile network identifier (PLMN ID) having a corresponding tracking area code (TAC), and a second PLMN ID with no corresponding TAC; and
to report the first PLMN ID and the corresponding TAC but not reporting the second PLMN ID while performing PLMN selection.

9. The apparatus of claim 8, in which the SIB1 message corresponds to a cell of the base station, and the cell is shared by a plurality of network operators.

10. The apparatus of claim 8, in which the first PLMN ID corresponds to a standalone mode (SA) deployment and the second PLMN ID corresponds to a non-standalone (NSA) deployment.

11. The apparatus of claim 8, in which the at least one processor causes the apparatus to report from an access stratum (AS) layer of the UE to a non-access stratum (NAS) layer of the UE.

12. The apparatus of claim 8, in which the at least one processor causes the apparatus to camp on a cell of the base station with the first PLMN ID.

13. The apparatus of claim 8, in which the at least one processor causes the apparatus to, during a manual PLMN selection procedure, report the first PLMN ID and the corresponding TAC but not reporting the second PLMN ID.

14. The apparatus of claim 8, in which the at least one processor causes the apparatus to, during a high priority PLMN selection procedure, report the first PLMN ID and the corresponding TAC but not reporting the second PLMN ID.

15. A non-transitory computer-readable medium storing instructions that, when executed by one or more processors of a user equipment (UE), cause the UE to:
decode a system information block, type one (SIB1) message received from a base station, the SIB1 message listing a first public land mobile network identifier (PLMN ID) having a corresponding tracking area code (TAC) and a second PLMN ID with no corresponding TAC; and
report the first PLMN ID and the corresponding TAC but not report the second PLMN ID while performing PLMN selection.

16. The non-transitory computer-readable medium of claim 15, wherein the SIB1 message corresponds to a cell of the base station, and the cell is shared by a plurality of network operators.

17. The non-transitory computer-readable medium of claim 15, wherein the first PLMN ID corresponds to a standalone mode deployment and the second PLMN ID corresponds to a non-standalone deployment.

18. The non-transitory computer-readable medium of claim 15, wherein the instructions, when executed by the one or more processors, further cause the UE to report from an access stratum layer of the UE to a non-access stratum layer of the UE.

19. The non-transitory computer-readable medium of claim 15, wherein the instructions, when executed by the one or more processors, further cause the UE to camp on a cell of the base station with the first PLMN ID.

20. The non-transitory computer-readable medium of claim 15, wherein the PLMN selection comprises a manual PLMN selection procedure, and the instructions, when executed by the one or more processors, further cause the UE to report the first PLMN ID and the corresponding TAC but not report the second PLMN ID during the manual PLMN selection procedure.
